(19) United States
(12) Patent Application Publication
(10) Pub. No.: US 2021/0091429 A1
(43) Pub. Date: Mar. 25, 2021

(54) VEHICLE BATTERY UNIT

(71) Applicant: HONDA MOTOR CO., LTD., Tokyo (JP)

(72) Inventors: Hidemi SEKI, Saitama (JP); Suguru MATSUNAGA, Saitama (JP); Takashi SONO, Saitama (JP); Hitoshi NUNAMI, Saitama (JP); Shogo IMAMURA, Saitama (JP); Shoji TSUKAMOTO, Saitama (JP)

(73) Assignee: HONDA MOTOR CO., LTD., Tokyo (JP)

(21) Appl. No.: 17/110,864

(22) Filed: Dec. 3, 2020

Related U.S. Application Data
(63) Continuation of application No. 16/211,596, filed on Dec. 6, 2018.

(30) Foreign Application Priority Data
Dec. 12, 2017 (JP) 2017-237830

(51) Int. Cl. H01M 10/6555; H01M 10/6567; H01M 10/613; H01M 10/625; H01M 10/6556; H01M 10/6568; H01M 2/10

(52) U.S. Cl. CPC H01M 10/6555; H01M 10/6567; H01M 10/613; H01M 2220/20; H01M 10/6556; H01M 10/6568; H01M 2/1077; H01M 10/625

(57) ABSTRACT

A vehicle battery unit includes: a battery module where a plurality of battery cells are stacked in a vehicle width direction and a module case for accommodating the battery module. The module case includes: a pair of side plates for holding side surfaces of the battery module; a bottom plate for connecting lower end portions of the pair of side plates to each other; and a pair of end blocks arranged at opposite end portions of the battery module in a stacking direction of the battery module for connecting the pair of side plates to each other. The end block is coupled to an end surface of the side plate in the stacking direction with a coupling bolt, and a thickness of the end block is greater than a thickness of the side plate.

### CROSS-REFERENCE TO RELATED APPLICATIONS

This application is a continuation of U.S. patent application Ser. No. 16/211,596 filed on Dec. 6, 2018, which is based on and claims priority under 35 USC 119 from Japanese Patent Application No. 2017-237830 filed on Dec. 12, 2017, the contents of which are incorporated herein by reference.

### TECHNICAL FIELD

The present invention relates to a vehicle battery unit mounted in a vehicle.

### BACKGROUND ART

Conventionally, a battery module has been mounted in an electric vehicle or the like. For example, Patent Literature 1 (US 2014/342195 (A)) discloses a battery module including a battery module and a module case accommodating the battery module (for example, Patent Literature 1).

In such a battery module, a load is generated in a cell stacking direction (hereinafter, referred to as a cell thickness constraint reaction force) due to a cell expansion caused by a temperature variation or aging. In recent years, according to an increase in a cell capacity and in energy density, there has been a tendency that more active materials are packed in a cell, whereby the cell thickness constraint reaction force has increased.

Also, a battery unit mounted in a vehicle needs to protect the battery module against an impact such as collision.

The present invention provides a vehicle battery unit which may appropriately protect the battery module.

### SUMMARY OF INVENTION

The present invention provides a vehicle battery unit including:

a battery module where a plurality of battery cells are stacked in a vehicle width direction; and

a module case for accommodating the battery- module, wherein

the module case includes:
a pair of side plates for holding side surfaces of the battery module;
a bottom plate for connecting lower end portions of the pair of side plates to each other; and
a pair of end blocks arranged at opposite end portions of the battery module in a stacking direction of the battery module for connecting the pair of side plates to each other,

the end block is coupled to an end surface of the side plate in the stacking direction with a coupling bolt, and.

a thickness of the end block is greater than a thickness of the side plate.

According to the present invention, an end block is coupled to an end surface of a side plate in a stacking direction with a coupling bolt. Therefore, the side plate has a predetermined thickness to hold the coupling bolt, however, the end block has a thickness that is greater than that of the side plate, whereby the battery module may be firmly held by the side plate and the end block.

Thus, the cell thickness constraint reaction force is received by the end block. Even when a load is input from outside of the end block, the load is received by the end block, and moreover, the end block and the side plate may be used as load path members so that the battery module can be appropriately protected.

### BRIEF DESCRIPTION OF THE DRAWINGS

Exemplary embodiment of the present invention will be described in detail based on the following figures, wherein:

FIG. 1 is a perspective view of a vehicle battery unit;

FIG. 2 is a perspective view of inside of the vehicle battery unit in FIG. 1;

FIG. 3 is a perspective view showing a main configuration of part A in FIG. 2;

FIG. 4 is a perspective view showing a main configuration of two battery modules in FIG. 3; and

FIG. 5 is a perspective cross-sectional view of a module case coupled to a battery case.

### DESCRIPTION OF EMBODIMENT

A vehicle battery unit (hereinafter, referred to as a battery unit) according to an embodiment will be described below with reference to drawings. In the drawings, a front portion of the battery unit is indicated by Fr, a rear portion is indicated by Rr, a left side is indicated by L, a right side is indicated by R, an upper portion is indicated by U, and a bottom portion is indicated by D.

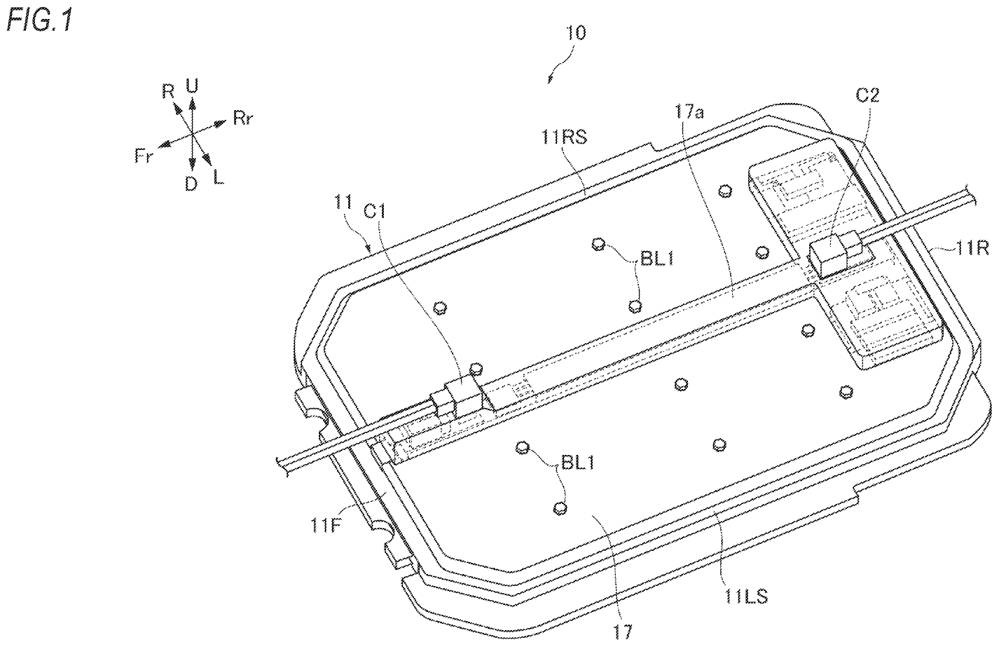

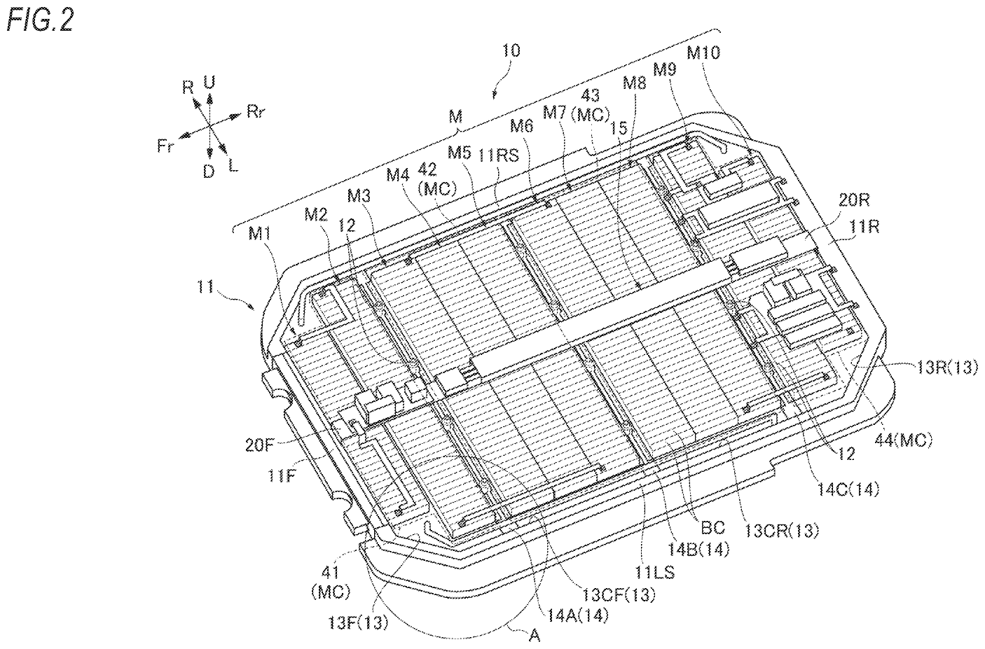

As shown in FIGS. 1 and 2, a vehicle battery unit 10 (namely, a battery unit for a vehicle) includes a battery module M, a module case MC for accommodating the battery module M, a battery case 11 for accommodating the module case MC, and connectors C1 and C2 installed on the battery case 11, and is disposed under a floor panel of a vehicle.

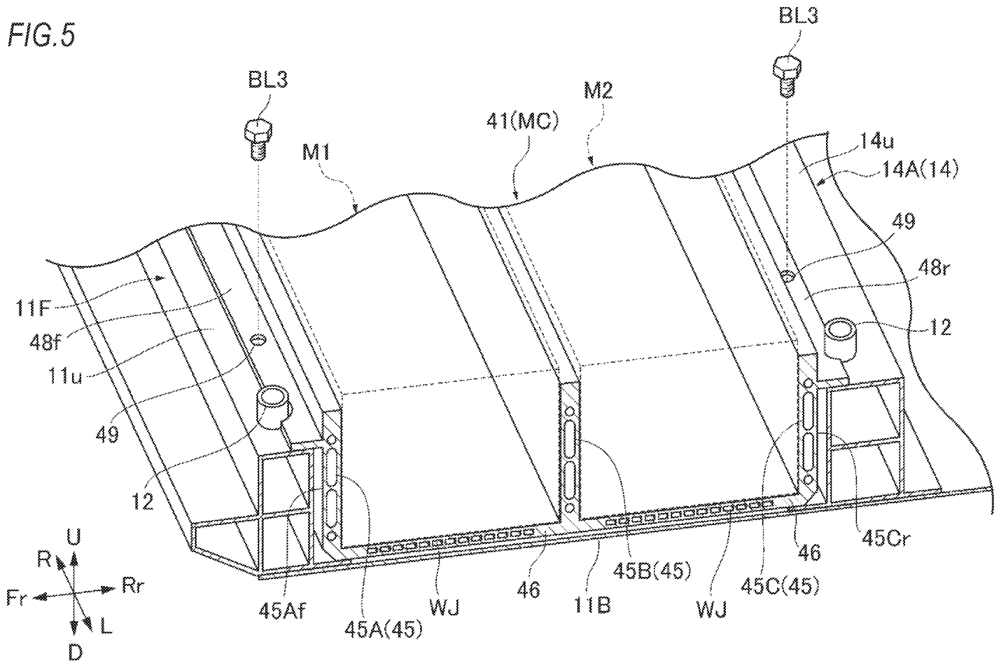

The battery case 11 includes a left side frame 11LS and a right side frame 11RS facing each other in a left-right direction (vehicle width direction) and a front frame 11F and a rear frame 11R facing each other in a front-back direction on a bottom plate 11B having a roughly rectangular shape (see FIG. 5), and a space surrounded by the left side frame 11LS, the right side frame 11RS, the front frame 11F, and the rear frame 11R configures a battery accommodation portion 13.

The battery accommodation portion 13 is provided between the front frame 11F and the rear frame 11R, and three cross members 14 (14A, 14B, and 14C) stretching in the left-right direction of the vehicle to be connected to the left side frame 11LS and the right side frame 11RS are partitioned into four battery accommodation portions 13F, 13CF, 13CR, and 13R.

The battery module M includes first to tenth modules M1 to M10 that are sequentially arranged in a front-back direction in ten rows. In each of the modules M1 to M10, a plurality of battery cells BC are stacked in the left-right direction.

The module case MC includes a first module case 41, a second module case 42, a third module case 43, and a fourth module case 44 that are sequentially arranged in the front-back direction in four rows.

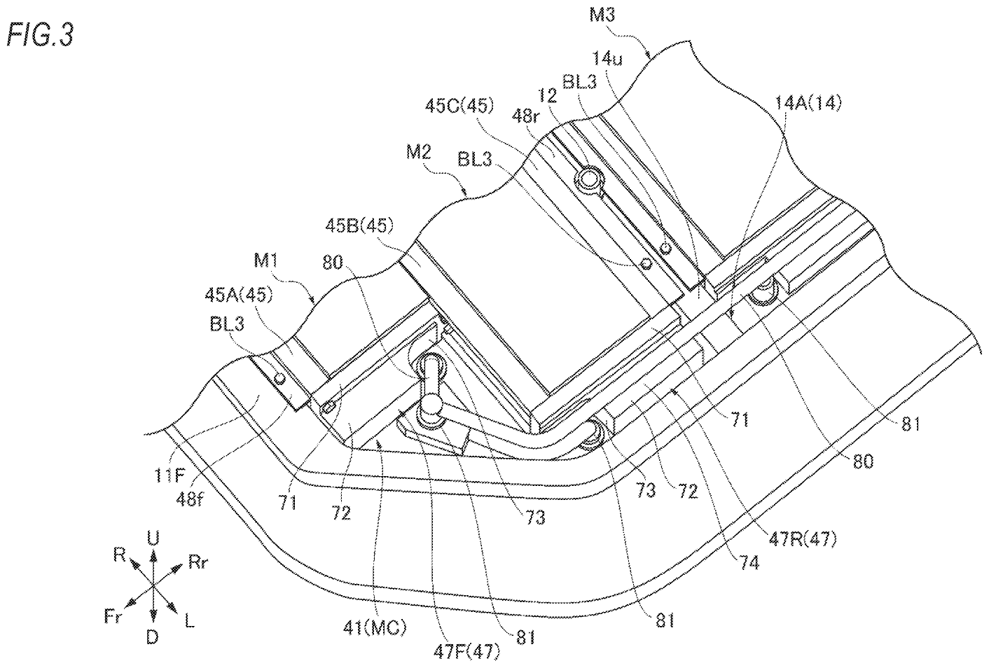

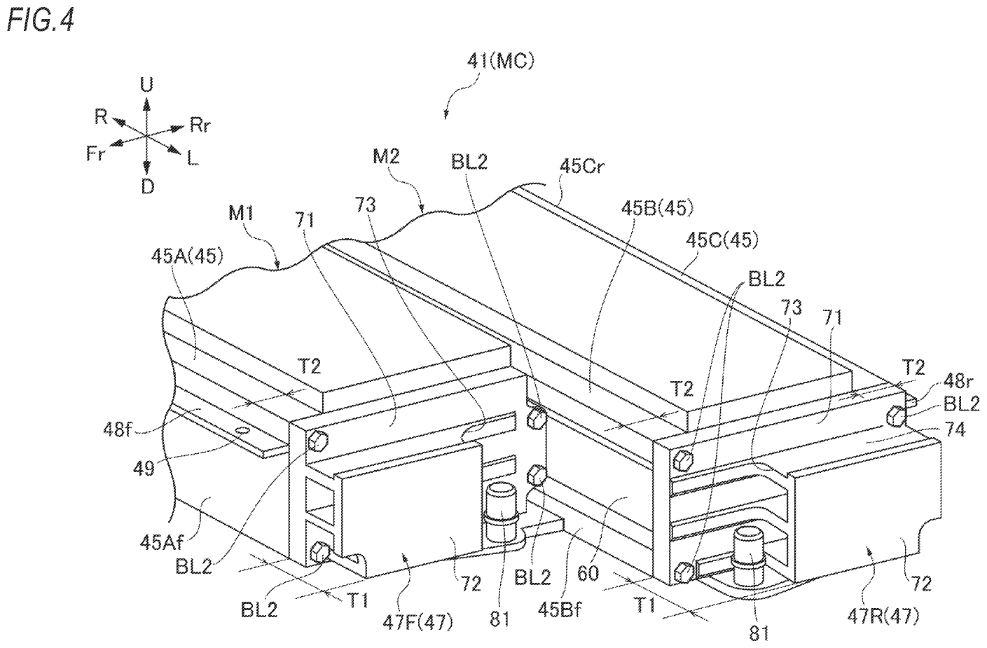

The first module M1 and the second module M2 are accommodated in the battery accommodation portion 13F at a frontmost portion in a state of being held by the first module case 41, the third to fifth modules M3 to M5 are accommodated in the battery accommodation portion 13CF behind the battery accommodation portion 13F in a state of being held by the second module case 42, the sixth to eighth modules M6 to M8 are accommodated in the battery accommodation portion 13CR behind the battery accommodation portion 13CF in a state of being held by the third module case 43, and the ninth and tenth modules M9 and M10 are accommodated in the battery accommodation portion 13R behind the battery accommodation portion 13CR in a state of being held by the fourth module case 44. In addition, in FIG. 2, the module cases 41 to 44 are briefly shown. A detailed structure of the module case MC will be described below with reference to FIGS. 3 to 5 using the first module case 41 as an example.

In addition, the battery case 11 includes a frame member 15 extending in a front-back direction of the vehicle to be connected to the front frame 11F and the rear frame 11R. The frame member 15 is disposed at a higher location than the battery module M and the cross member 14 via erected parts 20F and 20R.

The left side frame 11LS, the right side frame 11RS, the front frame 11F, the rear frame 11R, the cross member 14, and the frame member 15 constituting the battery case 11 are all metal-structural members. A structural member denotes an aggregate that forms the battery unit 10 as a structure, and is a member forming a load path for protecting the battery module M from an impact. The frame member 15 functions as a structural member for improving rigidity with respect to pitching of a vehicle. Therefore, electrical components such as the battery module M, accommodated in the battery case 11, are protected against an impact generated due to collision or the like of the vehicle.

The battery case 11 is covered by a metal cover 17. The cover 17 is fixed by fastening bolts BL1 into nuts 12 fixed on the cross members 14, and is bonded to the left side frame 11LS, the right side frame 11RS, the front frame 11F, and the rear frame 11R by welding or the like. A bulge portion 17a extending in the front-back direction is installed on a center portion of the cover 17 in the left-right direction along a shape of the frame member 15. In addition, the bulge portion 17a of the cover 17 is accommodated in a center tunnel that is formed in a floor panel. The first connector C1 is exposed from a front portion of the bulge portion 17a and the second connector C2 is exposed from a rear portion of the bulge portion 17a.

Hereinafter, the module case MC according to the present invention will be described in detail with reference to FIGS. 3 to 5.

The module case MC includes a pair of side plates 45 for holding side surfaces of the battery module M, a bottom plate 46 for connecting lower portions of the pair of side plates 45 to each other, and a pair of end blocks 47 arranged at opposite end portions (namely, both end portions) of the battery module M in a stacking direction of the battery module M to connect the pair of side plates 45 to each other. In the module case MC accommodating the battery modules M in a plurality of rows, at least one side plate 45 may be included both in a pair of side plates 45 supporting one row and in another pair of side plates 45 supporting another row.

In the following description, the first module case 41 will be described as an example, however, the second module case 42 to the fourth module case 44 may have configurations similar or identical to the first module case 41. Also, the first module case 41 has identical or similar structures at left and right sides thereof, and thus only a structure at the left side of the first module case 41 will be described below.

In the first module case 41 accommodating the first module MI and the second module M2, a front plate 45A, an intermediate plate 45B, and a rear plate 45C, extending in the left-right direction juxtaposed with one another, are arranged from the front, where the front plate 45A and the intermediate plate 45B form a space for accommodating the first module Ml and the intermediate plate 45B and the rear plate 45C form a space for accommodating the second module M2. The intermediate plate 45B is included in both of a pair of side plates 45 supporting the first module MI and another pair of side plates 45 supporting the second module M2.

Lower end portions of the front plate 45A, the intermediate plate 45B, and the rear plate 45C are integrally formed as a bottom plate 46. The bottom plate 46 includes a water jacket WJ integrally formed with the bottom plate 46 in the left-right direction, through which a refrigerant passes.

The intermediate plate 45B and the rear plate 45C are longer than the front plate 45A in the left-right direction, and a recess 60 is formed in a front surface 45Bf of the intermediate plate 45B. The recess 60 is formed in a left end surface of the intermediate plate 45B to the same position as a left end surface of the front plate 45A in the left-right direction. Therefore, an abutting surface is formed on the front surface 45Bf of the intermediate plate 45B at the same position as the left end surface of the front plate 45A.

A front end block 47F abuts on the left end surface of the front plate 45A and the abutting surface of the intermediate plate 45B and is fixed by the coupling bolt BL2, and a rear end block 47R abuts on the left end surface of the intermediate plate 45B and a left end surface of the rear plate 45C and is fixed by the coupling bolt BL2. The end block 47 (47F and 47R) is coupled to the end surface and the abutting surface of the side plate 45 (45A, 45B, and 45C) with the coupling bolt BL2, whereby the side plate 45 (45A, 45B, and 45C) has a predetermined thickness to satisfy rigidity that is necessary for holding the coupling bolt BL2.

Here, a thickness T1 of the end block 47 (47F and 47R) is greater than a thickness T2 of the side plate 45 (45A, 45B, and 45C). In addition, the thickness T1 of the end block 47 (47F and 47R) is a maximum width of the end block 47 (47F and 47R) in the left-right direction, and the thickness T2 of the side plate 45 (45A, 45B, and 45C) is a maximum width of the side plate 45 (45A, 45B, and 45C) in the front-back direction.

The front end block 47F includes a plate portion 71 having a uniform thickness and facing the left surface of the first module M1 and a block portion 72 bulging outwardly from the plate portion 71, and the rear end block 47R also includes the plate portion 71 having a uniform thickness and facing the left surface of the second module M2 and the block portion 72 bulging outwardly from the plate portion 71. Therefore, the thickness T1 of the end block 47 (47F and 47R) denotes a length obtained by adding the plate portion 71 and the block portion 72 of the end block 47 (47F and 47R).

As described above, the battery module M (M1 and M2) may be firmly held by the side plates 45 (45A, 45B, and 45C) and the end blocks 47 (47F and 47R). Therefore, even when a cell thickness constraint reaction force increases due to an expansion of the cell caused by a temperature variation or aging, the cell thickness constraint reaction force can be received by the end blocks 47 (47F and 47R). Even when a side collision load is input to the end block 47 (47F and 47R), the end block 47 (47F and 47R) may receive the side collision load, and moreover the battery module M (M1 and M1) may be appropriately protected using the end block 47 (47F and 47R) and the side plate 45 (45A, 45B, and 45C) as a load path. The thickness T1 of the end block 47 (47F and 47R) may be preferably twice the thickness T2 of the side plate 45 (45A, 45B, and 45C) or greater

A rear outer portion of the front end block 47F and a front outer portion of the rear end block 47R are connecting portion arranging places 73 where the block portion 72 is not provided to avoid a connecting portion 81 of a refrigerant pipe 80 that supplies the refrigerant to the water jacket WJ. The block portion 72 of the rear end block 47R is set to be lower than the plate portion 71, and an upper portion of the block portion 72 becomes a refrigerant pipe arranging portion 74 where the refrigerant pipe 80 is arranged. The refrigerant pipe arranging portion 74 is provided inside from an outer end surface of the rear end block 47R. Accordingly, even when the side collision load is input, leakage of the refrigerant from the refrigerant pipe 80 can be prevented.

Also, the module case MC is coupled to frame members adjacent thereto in the front-back direction by a coupling member to be suspended on upper surfaces of the frame members. When the first module case 41 is described in detail as an example, in the first module case 41 accommodating the first module M1 and the second module M2, a front flange 48f extends on a front surface 45Af of the front plate 45A in the left-right direction, and at the same time, a rear flange 48r extends on a rear surface 45Cr of the rear plate 45C in the left-right direction. Bolt holes 49 are formed in the front flange 48f and the rear flange 48r with predetermined intervals, and the front flange 48f is fixed to an upper surface 11u of a front frame 11F and the rear flange 48r is fixed to an upper surface 14u of the cross member 14A through the bolt holes 49. Therefore, the first module case 41 may be easily assembled with the battery case 11 from an upper direction. When the first module case 41 is moved relative to the front frame 11F and the cross member 14A, a bolt BL3 may break to absorb the side collision load.

The present invention is not limited to the above-described embodiments, and various modifications are included.

At least following is described in the present specification. The corresponding elements and the like in the above-described embodiments are indicated in parentheses, the present invention is not limited thereto.

(1) A vehicle battery unit 10 including a battery module M where a plurality of battery cells BC are stacked in a vehicle width direction, and

a module case MC for accommodating the battery module, wherein

the module case includes

a pair of side plates 45 for holding side surfaces of the battery module,

a bottom plate 46 for connecting lower end portions of the pair of side plates to each other, and

a pair of end blocks 47 arranged at opposite end portions of the battery module in a stacking direction of the battery module for connecting the pair of side plates to each other.

the end block is coupled to an end surface of the side plate in the stacking direction with a coupling bolt BL2, and

a thickness T1 of the end block is greater than a thickness T2 of the side plate.

According to (1), the end block is coupled to the end surface of the side plate in the stacking direction with the coupling bolt. Although the side plate has a predetermined thickness to hold the coupling bolt, the end block has a thickness that is greater than that of the side plate, whereby the battery module may be firmly held by the side plate and the end block. Therefore, the cell thickness constraint reaction force is received by the end block. Even when a load is input from the outside of the end block, the load can be received by the end block, and the battery module can be appropriately protected using the end block and the side plate as load path members.

(2) The vehicle battery unit according to (1), wherein

the thickness of the end block is twice the thickness of the side plate or greater.

According to (2), even when the side collision load is input to the end block, the battery module can be protected appropriately.

(3) The vehicle battery unit according to (1) or (2), wherein

the end block includes a refrigerant pipe arranging portion 74, in which a refrigerant pipe 80 is arranged, inside from the end surface of the end block in the stacking direction.

According to (3), since the refrigerant pipe arranging portion in which the refrigerant pipe is arranged is provided inside the end surface of the end block having high rigidity in the stacking direction, leakage of the refrigerant from the refrigerant pipe may be prevented even when the side collision load is input.

(4) The vehicle battery unit according to (3), wherein

a jacket portion (WJ) that is connected to the refrigerant pipe to cool down the battery module is integrally formed on the bottom plate.

According to (4), since the jacket portion is integrally formed on the bottom plate on which the battery module is mounted, wherein the battery module is arranged inside the end surface of the end block having high rigidity in the stacking direction, the leakage of refrigerant from the jacket portion can be prevented even when the side collision load is input.

(5) The vehicle battery unit according to (4), wherein

the bottom plate and the pair of side plates are integrally formed.

According to (5), since the side plate which is a load path member, is integrally formed with the bottom plate, the rigidity can be further improved.

(6) The vehicle battery unit according to one of (1) to (5), further including

a battery case 11 for accommodating the battery module held by the module case, wherein

the battery case includes a plurality of frame members 11F and 14 extending in a left-right direction of a vehicle, and

the module case is coupled to the frame members adjacent thereto in a front-back direction using a coupling member BL3.

According to (6), since the module case is coupled to a structural member using the coupling member, when the module case is moved relative to the frame members, the side collision load can be absorbed by breaking the coupling member.

(7) The vehicle battery unit according to (6), wherein

the module case is coupled to the frame members adjacent thereto in the front-back direction using the coupling member to be suspended on the upper surfaces 11u and 14u of the frame members.

According to (7), since the module case is coupled to the frame members adjacent thereto in the front-back direction using the coupling member to be suspended on the upper surfaces of the frame members, the module case may be easily assembled with the battery case from the upper portion.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment were chosen and described in order to best explain the principles of the invention and its practical applications, thereby enabling others skilled in the art to understand the invention for various embodiment and with the various modifications as are suited to the particular use contemplated. It is intended that the scope of the invention be defined by the following claims and their equivalents.

What is claimed is:

1. A vehicle battery unit, comprising:
a battery module; and
a battery case for accommodating the battery module, wherein
the vehicle battery unit includes a pair of plate portions arranged at opposite ends of the battery module in a stacking direction of battery cells,
a refrigerant pipe and a first block portion are arranged between a plate portion of the pair of plate portions and the battery case, and overlap each other in a direction orthogonal to the stacking direction,
a length of the first block portion in the stacking direction is longer than a length of the refrigerant pipe in the stacking direction, and
the refrigerant pipe is provided inside from an outer end surface of the first block portion.

2. The vehicle battery unit according to claim 1, wherein
the plate portion and the first block portion are designed to be integrated.

3. The vehicle battery unit according to claim 1, wherein
the vehicle battery unit includes a pair of side plates for holding side surfaces of the battery module, and
a side plate of the pair of side plates is connected to the plate portion.

4. The vehicle battery unit according to claim 1, wherein
an upper portion of the first block portion becomes a refrigerant pipe arranging portion of the refrigerant pipe.

5. The vehicle battery unit according to claim 4, wherein
a height of the outer end surface of the first block portion is greater than a height of the refrigerant pipe.

6. The vehicle battery unit according to claim 1, wherein
a height of the first block portion is smaller than a high of the plate portion.

7. The vehicle battery unit according to claim 1, comprising:
a bottom plate; and
a jacket portion integrally formed with the bottom plate, wherein
the jacket portion is connected to the refrigerant pipe via a connecting portion,
in a front-back direction of the vehicle, the first block portion and the connecting portion are provided at intervals.

8. The vehicle battery unit according to claim 7, wherein
the vehicle battery unit further includes a second block portion,
the connecting portion is located between the first block portion and the second block portion.

9. The vehicle battery unit according to claim 1, wherein
the block portion has a hollow structure.
